(19) United States
(12) Patent Application Publication
(10) Pub. No.: US 2011/0132339 A1
(43) Pub. Date: Jun. 9, 2011

(54) Multiple Coil Distributor and Method of Use Thereof

(76) Inventors: Jerry Hoffmann, Suwanee, GA (US); Matt Cramer, Covington, GA (US)

(21) Appl. No.: 12/631,104

(22) Filed: Dec. 4, 2009

(51) Int. Cl. F02P 7/03

(52) U.S. Cl. 123/643

(57) ABSTRACT

A multiple coil distributor comprising a distributor, a distributor cap and a plurality of ignition coils. The plurality of ignition coils are disposed with the distributor cap and individually connect to an associated spark plug. The multiple coil distributor further comprises an electronic control unit and a sensor mechanism. The sensor mechanism comprises a trigger wheel and is in electrical communication with the electronic control unit. Each individual ignition coil is in electrical communication with the electronic control unit. The multiple coil distributor provides a spark for an internal combustion via obtaining the multiple coil distributor, installing the multiple coil distributor within the engine compartment of a car, rotating the trigger wheel, signaling the electronic control unit via the sensor mechanism when the trigger wheel is a selected position and sparking a selected ignition coil corresponding to a selected spark plug via the electronic control unit.

### CROSS-REFERENCE TO RELATED APPLICATIONS

None

### FEDERALLY SPONSORED RESEARCH OR DEVELOPMENT

None

### PARTIES TO A JOINT RESEARCH AGREEMENT

None

### REFERENCE TO A SEQUENCE LISTING

None

### BACKGROUND OF THE INVENTION

1. Technical Field of the Invention

The preferred embodiment relates generally to a multiple coil distributor and method of use, and more specifically to a multiple coil distributor comprising a distributor, a distributor cap, a coil assembly and, optionally, an electronic control unit, wherein the coil assembly comprises a plurality of ignition coils, and wherein each of the plurality of ignition coils is in electrical communication with an assigned spark plug, and wherein the plurality of ignition coils are housed within the distributor.

2. Description of Related Art

Older vehicles and classic cars contain ignition systems designed prior to the age of modern ignition systems. Such ignition systems cause a variety of problems for car owners, such as start-up deficiency and/or heavy maintenance due to corrosion. Accordingly, owners of classic cars desire an efficient and easy way to modernize their older ignition systems, without sacrificing the soul and aesthetics of their classic car engine.

In such older vehicles, the distributor and ignition coil are separate units, with the ignition coil mounted separately from the distributor, and with spark plugs disposed remotely on each cylinder that are fired by the coil through the distributor. The distributor has a rotating shaft inside. Attached to the rotating shaft is a rotor, which turns with the shaft and makes contact with a connecting point for the wire from the spark plugs entering the distributor cap. Outside the distributor cap is the ignition coil, which directs energy to the distributor, and the coil receiving its energy from an external power supply, such as the battery of the vehicle. The ignition coil is triggered to fire typically by contact points within the distributor that open and close. The contact points are driven from a cam on the rotating shaft in the distributor. Thus, when the primary circuit of the ignition coil is closed and opened by the points, a burst of energy is generated in the secondary coil of the ignition coil and sent to the distributor rotor, such that the rotor “distributes” energy to a selected spark plug based on the rotational position of the rotor.

Unfortunately, as the contact points open and close, a small spark is generated between the contacts of the points. This small spark, occurring many times per second, etches the contact metal of the points, leading to gradual worsening of the ability of the contacts of the points to provide a uniform contact surface. Thus, pitting occurs, leading to irregularities in the surface of the contacts, thereby reducing efficiency and thus reducing the energy generated by the coil, since it receives it primary circuit energy through the points.

As technology has progressed, new ignition systems have been introduced to replace older ignition systems. Particularly, devices have been incorporated within the distributor to replace the points because of the aforementioned problems, including deterioration of the points due to spark etching. Such devices include electronic switches that typically operate via Hall effect, magnetic induction (reluctors) or optoelectronic chopping.

Unlike older engines, most modern engines utilize an electronic control system (ECS). Such electronic control systems must still sense the engine position (vis-à-vis the selected cylinder for spark energizing). These systems generate the signals necessary for an ignition coil to fire its secondary coil, thereby creating a spark in the spark plug that is in electrical communication either with the coil itself or with a distributor. For systems where the coil is in direct electrical communication with a spark plug, coil-on-plug systems may be utilized, wherein individual ignition coils are mounted directly on each spark plug at the cylinder, such that each plug has its own coil. However, attaching ignition coils directly on the spark plugs changes the aesthetics associated with classic car engines. Further, classic car engines may lack the space needed to mount ignition coils directly over each spark plug. Accordingly, there is a need for an apparatus that allows multiple ignition coils to be mounted, each connecting directly to a spark plug via a coil-per-plug method, wherein the coils are housed within the distributor cap to maintain classic car engine aesthetics, but where the coils each connects to a different spark plug.

A particular advantage of having separate coils associated with individual spark plugs is that such overcomes the reverse electromotive force (EMF) caused by the collapsing magnetic field that opposes the buildup of a new charge within a coil. That is, with a single coil providing energy for a spark to all of the spark plugs in sequence, after firing a first plug, the coil will need to fire a second plug very soon thereafter (during a fraction of the rotation of the engine crankshaft). Because the magnetic field from firing the first plug is collapsing, it will work against the new field that is forming to deliver energy to fire the second plug.

### Wasted Spark

Unfortunately, increasing the number of coils also increases costs. The number of individual coils required to provide energy to the spark plugs may be reduced utilizing the “wasted spark” method. In this method, one ignition coil serves two spark plugs in separate cylinders, generating a burst of energy that flows to two spark plugs simultaneously. In one cylinder that is nearing the end of its compression stroke, the fuel is ignited by the spark plug as normally takes place to initiate the power stroke of the engine. However, the spark in the other cylinder takes place as the piston is nearing the end of its exhaust stroke, and, thus, has no effect and is “wasted”. Accordingly, utilizing the wasted spark method, a reduced number of coils is utilized since each coil drives two spark plugs. Such reduction cannot be accomplished if, as in the coil-on-plug structure, each plug has its own coil. As such, the two plugs connected to a given coil will fire once per crankshaft rotation, alternating the cylinder in which fuel is ignited every rotation (if the plugs are designated to fire).

Various devices have been developed to overcome some of the aforementioned disadvantages. For example, one device teaches an internal combustion engine ignition distributor cap and coil assembly. The device includes a housing member, enclosing the windings of a single ignition coil that is secured to the cap member of the distributor to create a singular integrated unit. While such a device allows a car owner to upgrade the engine of their classic car, unfortunately, because of its single coil limitation, such a device does not provide the efficiencies of individual coils associated with one or two spark plugs.

Yet another device teaches an ignition system with dual ignition coils, wherein one coil can fire two spark plugs simultaneously. Although the wasted spark method is utilized in this device, the ignition coils are positioned outside the distributor housing. Such requires additional mounting components for the second coil in the engine compartment and additional cabling between the distributor and the coils, and further destroys the aesthetics of a classic vehicle.

Therefore, it is readily apparent that there is a need for an apparatus that allows car owners to easily and efficiently upgrade older engines, while also maintaining classic car engine aesthetics.

### BRIEF SUMMARY OF THE INVENTION

Briefly described, in a preferred embodiment, the present invention overcomes the above-mentioned disadvantages and meets the recognized need for such an apparatus by providing a multiple coil distributor comprising a distributor, a distributor cap, a coil assembly and an electronic control unit, wherein the coil assembly comprises a plurality of ignition coils, and wherein each of the plurality of ignition coils is in electrical communication with an assigned spark plug, and wherein the ignition coils are disposed within the distributor. By including the coils within the distributor, not only are aesthetics improved for retrofitted classic vehicles, but electrical connection to the coils is simplified. Further, the coils may be utilized in a wasted spark configuration as discussed hereinabove.

Optionally, an engine management system (EMS) (which would otherwise also require additional mounting components and destroy the aesthetics of a classic vehicle) may be incorporated within the distributor. Such an EMS may include electronic fuel injection (EFI) control for those vehicles equipped with fuel injection, and may include sensing of oxygen fed to the engine to mix with the fuel, knock sensors, and the like.

According to its major aspects and broadly stated, the present invention in its preferred form is a multiple coil distributor comprising a distributor, a distributor cap and a plurality of ignition coils. The plurality of ignition coils are disposed within the distributor cap and each of the plurality of ignition coils is in electrical communication with an assigned spark plug. The multiple coil distributor further comprises an electronic control unit and a sensor mechanism. The ignition coils and the sensor are in electrical communication with the electronic control unit.

In an alternate embodiment, the plurality of ignition coils form a coil pack and the coil pack slides into the distributor cap. The coil pack further comprises an external contact. The plurality of coils are in electrical communication with the external contact and the external contact is in electrical communication with ground. It will be recognized by those skilled in the art that the contact points may be, for exemplary purposes only, spring loaded. It will be recognized by those skilled in the art that the coil pack and distributor cap may be built as a single unit.

The sensor mechanism is selected from Hall Effect sensors, optoelectronic sensors, reluctors, and the like. The sensor mechanism comprising a Hall Effect sensor further comprises a trigger wheel. The trigger wheel comprises outside teeth spaced apart by outer gaps that correspond to a respective spark plug. The trigger further comprises an inner ridge having an inner gap. It will be recognized by those skilled in the art that the trigger wheel may comprise, for exemplary purposes only, any pattern of teeth, including, but not limited to, a missing tooth wheel, wherein a selected tooth or multiple teeth may be omitted from the wheel layout, and wherein certain missing tooth wheel arrangements will allow the secondary sensor to be omitted when utilized with a suitable EMS.

The sensor mechanism further comprises a secondary sensor and a primary sensor. The secondary sensor is dimensioned to receive the outside teeth of the trigger wheel. The primary sensor is dimensioned to receive the inner ridge of the trigger wheel. Rotation of the trigger wheel rotates the outside teeth through the secondary sensor of the sensor mechanism and also rotates the inner ridge through the primary sensor of the sensor mechanism. The primary sensor sends a signal to the electronic control unit when the primary sensor is transitioned by the inner gap, thereby indicating the engine is at top dead center. The secondary sensor sends a signal to the electronic control unit when the secondary sensor is transitioned by the outer gaps, thereby generating a spark to a selected ignition coil and corresponding spark plug. It will be recognized by those skilled in the art that the sensor mechanism may utilize additional sensors.

The electronic control unit may optionally be disposed with the distributor. Additionally, the electronic control unit may further comprise additional sensor inputs for air and coolant temperature and throttle position, as well as other inputs, such as, for exemplary purposes only, a MAP sensor or general input/output sensors.

The preferred embodiment further comprises a method of providing a spark for an internal combustion engine comprising the steps of obtaining a multiple coil distributor having a distributor, a distributor cap, a plurality of ignition coils housed within the distributor cap, a sensor mechanism comprising a trigger wheel and an electronic control unit, and installing such within the engine compartment of a car. The method further comprises the steps of rotating the trigger wheel, signaling the electronic control unit via the sensor mechanism when the trigger wheel is a selected position and sparking a selected ignition coil corresponding to a selected spark plug, via said electronic control unit.

Additionally, the preferred embodiment is a multiple coil distributor comprising a distributor, a distributor cap and ignition coils within the distributor cap. The multiple coil distributor further comprises a sensor mechanism, a trigger wheel and an electronic control unit. The electronic control unit is in electrical communication with the sensor mechanism and sparks a selected ignition coil that corresponds to a spark plug.

More specifically, the present invention is a multiple coil distributor positioned inside the engine compartment of a car. The multiple coil distributor connects to spark plugs via wires. The wires have first ends and second ends. The first ends of the wires are secured to the spark plugs. The second ends of the wires secured to the multiple coil distributor. It will be recognized by those skilled in the art that the multiple coil distributor is not tied to a particular engine type of family, and can be fitted to three-cylinder, four-cylinder, five-cylinder, six-cylinder, eight-cylinder, ten-cylinder or twelve-cylinder engines, without limitation.

The multiple coil distributor further comprises coil contact receptacles, a distributor cap, ignition coils, contact blocks, a base plate, a sensor mechanism, trigger wheel housing, shaft housing, a gear and a distributor shaft. The ignition coils comprise tops and bottoms. The contact blocks are secured to the ignition coils and comprise contacts having positive terminals, negative terminals and trigger terminals. The contacts are in electrical communication with an Engine Management System (EMS) utilizing connectors and a first cable. The EMS controls ignition timing by sending a signal to a selected trigger terminal to fire a selected ignition coil. The sensor mechanism is also in electrical communication with the EMS utilizing a second cable, such that the sensor mechanism sends a signal to the EMS that is indicative of the position of the shaft during rotation of the shaft. The EMS may optionally be housed within the multiple coil distributor.

The distributor cap comprises a top surface and a body. The top surface comprises apertures and the body comprises cutouts. The coil receptacles are disposed on the tops of the ignition coils, and the bottoms of the ignition coils are disposed on the contact blocks. The contact blocks are disposed around the periphery of the base plate. The distributor cap is placed over the ignition coils and the coil receptacles extend through the apertures on the lid of the distributor cap, such that the cutouts are dimensioned to fit around and expose the contact blocks. The distributor cap is secured to the base plate and the trigger wheel housing utilizing fasteners disposed on the periphery of the base plate. The fasteners attach and secured to apertures located on the trigger wheel housing.

The sensor mechanism comprises the trigger wheel and a sensor mounting plate. The sensor mounting plate comprises a bottom, an aperture, a positive wire and a negative wire. The bottom of the sensor mechanism comprises a primary sensor and a secondary sensor, both of which are in electrical communication with the EMS. The primary sensor comprises an inner sensor wire, and the secondary sensor comprises an outer sensor wire. The positive wire, the negative wire, the inner sensor wire and the outer sensor wire collectively comprise the second cable. The sensor mechanism is in electrical communication with the EMS via the second cable. It will be recognized by those skilled in the art that the sensor mechanism could comprise a variety of sensors, such as, Hall Effect sensors, optoelectronic sensors, reluctors, and the like.

The sensor mechanism, including the trigger wheel, is housed within the trigger wheel housing. The trigger wheel housing comprises an entrance, a base and an aperture. The trigger wheel is secured to the base of the trigger wheel housing. The trigger wheel is secured to the distributor shaft. The shaft housing is hollow and receives the distributor shaft, such that the distributor shaft is inserted into the shaft housing through the aperture of the trigger wheel housing and also through the aperture of the sensor mechanism.

The trigger wheel comprises a bottom plate. The bottom plate comprises outside teeth, outer gaps, an inner ridge and an aperture. The inner ridge comprises an inner gap. The outside teeth and the outer gaps are spaced, for exemplary purposes only, sixty degrees apart (for a six cylinder engine) along the periphery of the bottom plate. The outside teeth and their associated outer gaps each correspond to different spark plugs, such that the trigger wheel may be synchronously and mechanically associated with the rotation of the engine of the car. The sensor mechanism is disposed above the trigger wheel, such that the primary sensor receives the inner ridge of the trigger wheel, and the secondary sensor receives the outside teeth of the trigger wheel. The trigger wheel is constructed from a material selected to cause a signal to be generated by the secondary sensor when the outside teeth and outer gaps transition through the secondary sensor. Similarly, when the inner ridge is rotated within the primary sensor, a signal will be sent to the EMS whenever the inner gap is encountered by the primary sensor. It will be recognized by those skilled in the art that other trigger wheels may be utilized, such as, for exemplary purposes only, trigger wheels having a larger number of teeth and gaps than the number of engine cylinders being utilized.

In use, the distributor shaft is in rotational communications with the crankshaft of the engine of the car. The distributor shaft is rotated via the gear, thereby rotating the trigger wheel. As the trigger wheel rotates, the outside teeth of the trigger wheel pass through the secondary sensor, and the inner ridge of the trigger wheel passes through the primary sensor. When the primary sensor is aligned with the inner gap, the primary sensor sends a signal to the EMS via the second cable, indicating the engine is at Top Dead Center (TDC). Subsequently, the EMS determines which cylinder needs a spark, and utilizes the secondary sensor. A signal is sent from the secondary sensor to the EMS when the outside teeth transition to the outer gaps, such that the EMS sends a signal, via the second cable, to a selected trigger terminal, thereby causing a selected ignition coil, which is in electrical communication with a spark plug via the cables, to generate a spark to its associated spark plug.

In another embodiment, the multiple coil distributor comprises primary ignition coils, secondary ignition coils, a transistor and a base plate. The base plate comprises a 12V battery, a primary ground and a secondary ground. The 12V battery, the primary ground and the secondary ground are concentric circles located on the same horizontal plane. The primary ignition coils contact the transistor and the 12V terminal. The 12V terminal is in electrical communication with the 12V battery. The secondary ignition coils contact the secondary ground terminal and the coil contact receptacles. The secondary ground terminal is in electrical communication with the secondary ground. The transistor is in electrical communication with the ECU trigger, and the ECU trigger is in contact with the primary ground terminal. The primary ground terminal is in electrical communication with the primary ground. In use, the ECU trigger receives a signal from a computer, which activates the transistor and energizes the primary ignitions coils. The primary ignition coils then energize the secondary ignition coils, which generate a spark in the spark plugs through the coil contact receptacles.

In an alternate embodiment, the base plate comprises a 12V battery, a primary ground and a secondary ground, and the 12V battery, the primary ground and the secondary ground are concentric circles located on the same vertical plane.

In another preferred embodiment of the multiple coil distributor, a coil pack slides into a distributor cap. The coil pack comprises primary ignition coils, secondary ignition coils, the transistor and the base plate. The base plate 180 comprises 12V battery 210, primary ground 211 and secondary ground 212, and wherein primary ground 211 and secondary ground 212 are concentric circles on the same horizontal plane. Primary ignition coils 43 contact transistor 217 and 12V terminal 200, wherein 12V terminal 200 is in electrical communication with 12V battery 210. Secondary ignition coils 46 contact secondary ground terminal 230 and coil contact receptacles 20, wherein secondary ground terminal 230 is in electrical communication with secondary ground 212, and wherein secondary ground terminal 230 is external to distributor cap 290. Transistor 217 is in electrical communication with ECU trigger 218 and is in contact with primary ground terminal 231, wherein primary ground terminal 231 is in electrical communication with primary ground 211, and wherein primary ground terminal 231 is external to distributor cap 290. In use, ECU trigger 218 receives a signal from a computer, wherein the signal activates transistor 217 which energizes primary ignitions coils 43, wherein primary ignition coils 43 are powered via 12V terminal 200. Primary ignition coils 43 then energize secondary ignition coils 46, wherein secondary coils 46 generate a spark in spark plug 12 through coil contact receptacles 20.

It will be recognized by those skilled in the art that the EMS could further comprise additional sensor inputs for air and coolant temperature and throttle position. Additionally, the EMS could further comprise output connectors for an idle valve or for fuel injectors. Lastly, it will be recognized by those skilled in the art that a “fake” vacuum advance canister may be fitted to the side of the multiple coil distributor, thereby providing a stock-appearing engine distributor. This could be utilized to obtain a MAP signal for any internal combustion engine.

Additionally, in an alternate embodiment, the plurality of coils having contact points forms a coil pack, wherein the coil pack slides in and out of the distributor cap. The coil pack further comprises a common external contact. The plurality of coils are in electrical communication with the external contact and the common external contact is in electrical communication with ground. It will be recognized by those skilled in the art that the contact points may be, for exemplary purposes only, spring loaded, and press into the base of the distributor. It will also be recognized by those skilled in the art that the coil pack and the distributor cap may be built together to form a single unit.

Accordingly, a feature and advantage of the preferred embodiment is its ability to provide a modernized high output coil-per-plug and/or coil-per-pair of plugs ignition system in a classic vehicle appearance package.

Still another feature and advantage of the preferred embodiment is its compatibility with aftermarket engine management systems.

Yet another feature and advantage of the preferred embodiment is its ability to easily modernize the ignition of classic cars without sacrificing the appearance of the vehicle.

Yet still another feature and advantage of the preferred embodiment is its ability to provide efficiency of ignition due to individual coils per plug.

Yet another feature and advantage of the preferred embodiment is its ability to eliminate separate mounting facilities required to install an ignition system and to reduce cabling between a distributor, multiple coils and their spark plugs.

Still another feature and advantage of the preferred embodiment is its ability to permit utilization of a wasted spark structure and method.

These and other features and advantages of the present invention will become more apparent to one skilled in the art from the following description and claims when read in light of the accompanying drawings.

### BRIEF DESCRIPTION OF THE SEVERAL VIEWS OF THE DRAWINGS

The present invention will be better understood by reading the Detailed Description of the Preferred and Selected Alternate Embodiments with reference to the accompanying drawing figures, in which like reference numerals denote similar structure and refer to like elements throughout, and in which:

FIG. 1 is a perspective view of a vehicle shown with a multiple coil distributor according to a preferred embodiment;

FIG. 2 is a perspective view of a multiple coil distributor according to a preferred embodiment, shown connected to an Engine Management System (EMS);

FIG. 3 is an exploded perspective view of a multiple coil distributor according to a preferred embodiment;

FIG. 4 is an exploded perspective view of a trigger wheel and a sensor according to a preferred embodiment;

FIG. 5A is a perspective view of a coil assembly according to a preferred embodiment;

FIG. 5B is a perspective view of a coil assembly according to an alternate embodiment; and

FIG. 6 is a cutaway perspective view of a coil pack inside a distributor cap according to an alternate embodiment.

### DETAILED DESCRIPTION OF THE PREFERRED AND SELECTED ALTERNATE EMBODIMENTS OF THE INVENTION

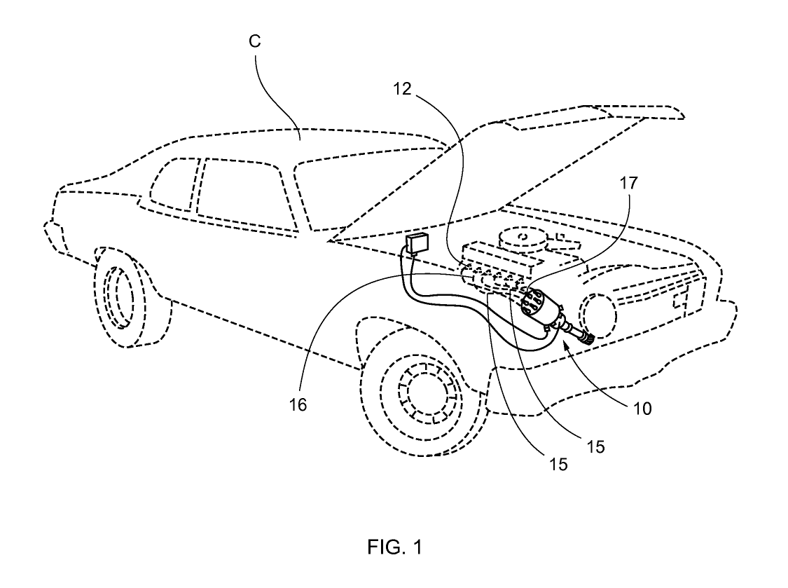

In describing the preferred and selected alternate embodiments of the present invention, as illustrated in FIGS. 1-6, specific terminology is employed for the sake of clarity. The invention, however, is not intended to be limited to the specific terminology so selected, and it is to be understood that each specific element includes all technical equivalents that operate in a similar manner to accomplish similar functions.

Referring now to FIG. 1, multiple coil distributor 10 is positioned inside the engine compartment of car C. Multiple coil distributor 10 connects to spark plugs 12 via wires 15, wherein wires 15 comprise first ends 16 and second ends 17, and wherein first ends 16 of wires 15 are secured to spark plugs 12, and wherein second ends 17 of wires 15 are secured to multiple coil distributor 10. It will be recognized by those skilled in the art that multiple coil distributor 10 is not tied to a particular engine type of family, and can be fitted to, without limitations and for exemplary purposes only, three-cylinder, four-cylinder, five-cylinder, six-cylinder, eight-cylinder, ten-cylinder or twelve-cylinder engines.

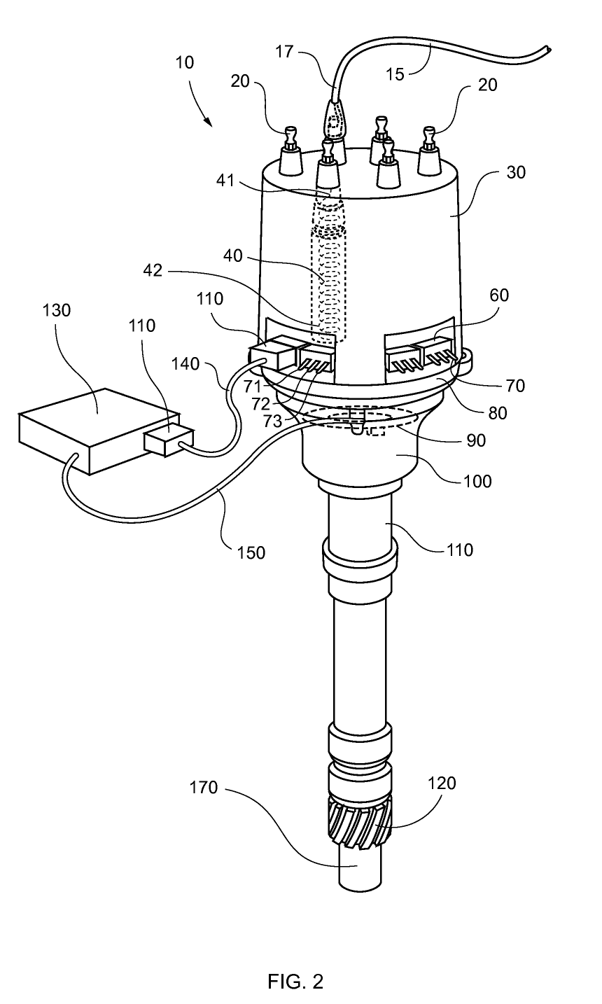

Referring now to FIG. 2, multiple coil distributor 10 comprises coil contact receptacles 20, distributor cap 30, ignition coils 40, contact blocks 60, base plate 80, sensor mechanism 90, trigger wheel housing 100, shaft housing 110, gear 120 and distributor shaft 170, wherein ignition coils 40 comprise tops 41 and bottoms 42. Contact blocks 60 are fixedly secured to ignition coils 40, wherein contact blocks 60 comprise contacts 70, and wherein contacts 70 comprise positive terminals 71, negative terminals 72 and trigger terminals 73. Contacts 70 are in electrical communication with Engine Management System (EMS) 130 via connectors 110 and first cable 140, wherein EMS 130 controls ignition timing by sending a signal to a selected trigger terminal 73 to fire a selected ignition coil 40. Sensor mechanism 90 is also in electrical communication with EMS 130 via second cable 150, wherein sensor mechanism 90 sends a signal to EMS 130 that is indicative of the position of distributor shaft 170 during rotation of distributor shaft 170. EMS 130 may optionally be disposed within multiple coil distributor 10.

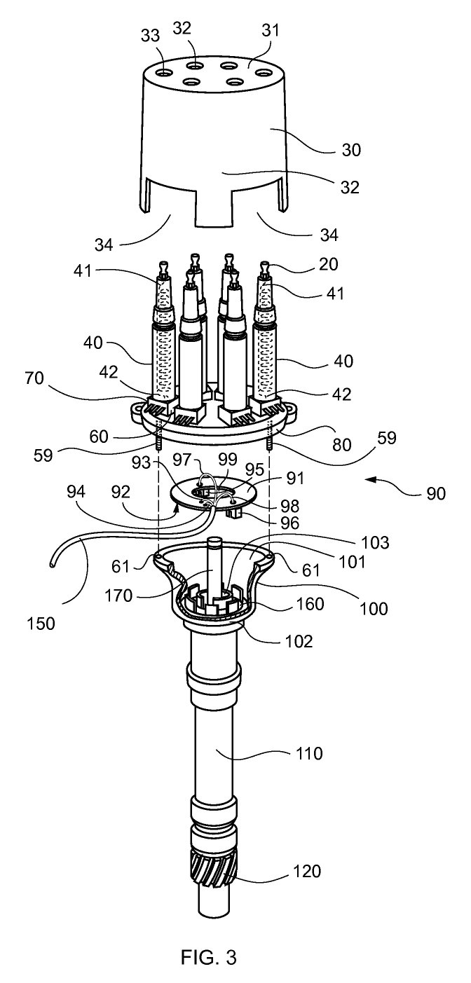

Referring now to FIG. 3, distributor cap 30 comprises top surface 31 and body 32, wherein top surface 31 comprises apertures 33, and wherein body 32 comprises cutouts 34. Coil receptacles 20 are disposed on tops 41 of ignition coils 40, wherein bottoms 42 of ignition coils 40 are disposed proximate contact blocks 60, and wherein contact blocks 60 are disposed around the periphery of base plate 80. Distributor cap 30 is placed over ignition coils 40, wherein coil receptacles 20 extend through apertures 33 on top surface 31 of distributor cap 30, and wherein cutouts 34 are dimensioned to fit around and expose contact blocks 60. Distributor cap 30 is selectively secured to base plate 80 and trigger wheel housing 100 via, for exemplary purposes only, fasteners 59, wherein fasteners 59 are disposed on the periphery of base plate 80, and wherein fasteners 59 are secured via apertures 61 located on trigger wheel housing 100. It will be recognized by those skilled in the art that distributor cap 30 comprises, for exemplary purposes only, plastic material.

Still referring to FIG. 3, sensor mechanism 90 comprises trigger wheel 160, sensor mounting plate 91, bottom 92, aperture 99, positive wire 93 and negative wire 94, wherein bottom 92 comprises primary sensor 95 and secondary sensor 96, both in electrical communication with EMS 130, and wherein primary sensor 95 comprises inner sensor wire 97, and wherein secondary sensor 96 comprises outer sensor wire 98. Positive wire 93, negative wire 94, inner sensor wire 97 and outer sensor wire 98 comprise second cable 150, wherein sensor mechanism 90 is in electrical communication with EMS 130 via second cable 150. It will be recognized by those skilled in the art that sensor mechanism 90 could comprise a variety of sensors known in the art, such as, for exemplary purposes only, Hall Effect sensors, optoelectronic sensors, reluctors, and the like.

Still referring to FIG. 3, sensor mechanism 90 is disposed within trigger wheel housing 100, wherein trigger wheel housing 100 comprises entrance 101, base 102 and aperture 103, and wherein trigger wheel 160 is secured to distributor shaft 170. Shaft housing 110 is hollow and dimensioned to receive distributor shaft 170, such that distributor shaft 170 is inserted into shaft housing 110, through aperture 103 of trigger wheel housing 100 and also through aperture 99 of sensor mechanism 90.

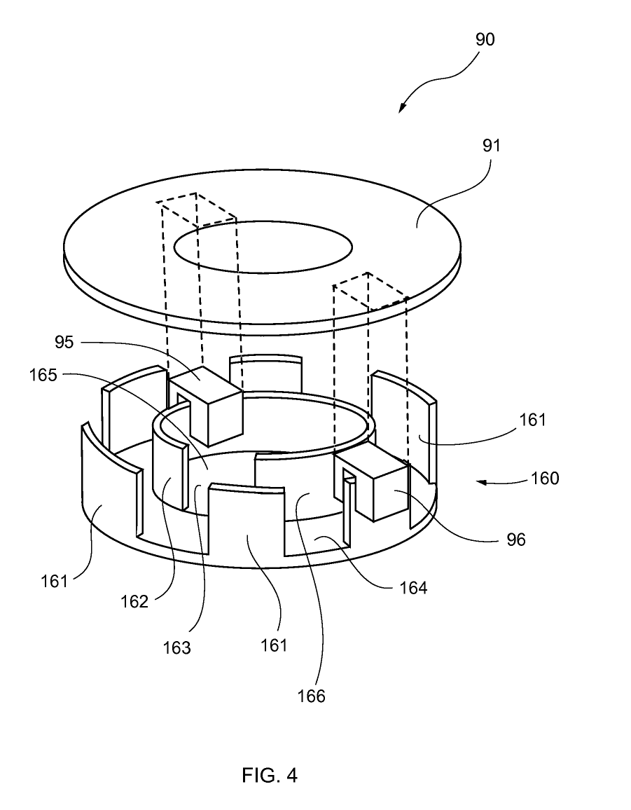

Referring now to FIG. 4, depicted therein is an exploded view of sensor mechanism 90, wherein trigger wheel 160 comprises bottom plate 164, and wherein bottom plate 164 comprises outside teeth 161, outer gaps 166, inner ridge 162 and aperture 165, and wherein inner ridge 162 comprises inner gap 163. Outside teeth 161 are spaced, for exemplary purposes only, sixty degrees apart (for a six cylinder engine) along the periphery of bottom plate 164 and outer gaps 166 are spaced, for exemplary purposes only, sixty degrees apart (for a six cylinder engine), wherein outside teeth 161 and their associated outer gaps 166 each correspond to different spark plugs 12, such that trigger wheel 160 may be synchronously and mechanically associated with the rotation of the engine of car C. Sensor mechanism is disposed above trigger wheel 160, wherein primary sensor 95 is dimensioned to receive inner ridge 162 of trigger wheel 160, and wherein secondary sensor 96 is dimensioned to receive outside teeth 161 of trigger wheel 160. It will be recognized by those skilled in the art that trigger wheel 160 is constructed from a material selected to cause a signal to be generated by primary sensor 95 and secondary sensor 96 when outside teeth 161 and inner gap 163 are rotated through sensor 160, as such is known in the art. Further, those skilled in the art will recognize that when inner ridge 162 is rotated within primary sensor 95, a signal will be sent to EMS 130 whenever inner gap 163 is encountered by primary sensor 95.

In use, distributor shaft 170 is in rotational communications with the crankshaft (not shown) of the engine of car C, wherein distributor shaft 170 is rotated via gear 120, thereby rotating trigger wheel 160. As trigger wheel 160 rotates, outside teeth 161 of trigger wheel 160 pass through secondary sensor 96, and inner ridge 162 of trigger wheel 160 passes through primary sensor 95. When primary sensor 95 is aligned with inner gap 163, primary sensor 95 sends a signal to EMS 130 via second cable 150, indicating the engine is at Top Dead Center (TDC). Subsequently, EMS 130 determines which cylinder needs a spark, utilizing secondary sensor 96, wherein a signal is sent from secondary sensor 96 to EMS 130 when outside teeth 161 transition to outer gaps 166, and wherein EMS 130 sends a signal via second cable 150 to a selected trigger terminal 73, thereby causing selected ignition coils 40 to generate a spark to its associated spark plug 12, and wherein ignition coils 40 are in electrical communication with spark plugs 12 via cables 15.

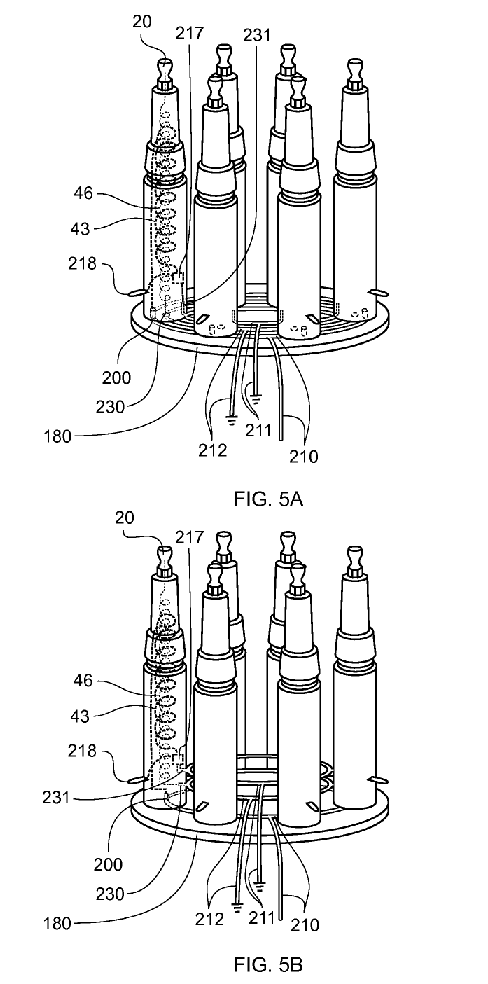

Referring now more specifically to FIG. 5A, illustrated therein is an alternate embodiment of multiple coil distributor 10, wherein the alternate embodiment of FIG. 5A is substantially equivalent in form and function to that of the preferred embodiment detailed and illustrated in FIGS. 1-4 except as hereinafter specifically referenced. Specifically, the embodiment of FIG. 5A comprises primary ignition coils 43, secondary ignition coils 46, transistor 217 and base plate 180, wherein base plate 180 comprises 12V battery 210, primary ground 211 and secondary ground 212, and wherein 12V battery 210, primary ground 211 and secondary ground 212 are concentric circles on the same horizontal plane. Primary ignition coils 43 contact transistor 217 and 12V terminal 200, wherein 12V terminal 200 is in electrical communication with 12V battery 210. Secondary ignition coils 46 contact secondary ground terminal 230 and coil contact receptacles 20, wherein secondary ground terminal 230 is in electrical communication with secondary ground 212. Transistor 217 is in electrical communication with ECU trigger 218, wherein transistor 217 is in contact with primary ground terminal 231, and wherein primary ground terminal 231 is in electrical communication with primary ground 211. In use, ECU trigger 218 receives a signal from a computer, which activates transistor 217 and energizes primary ignitions coils 43, wherein primary ignition coils 43 are powered via 12V terminal 200. Primary ignition coils 43 then energize secondary ignition coils 46, wherein secondary ignition coils 46 generate a spark in spark plug 12 through coil contact receptacles 20.

Referring now more specifically to FIG. 5B, illustrated therein is an alternate embodiment of FIG. 5A, wherein the alternate embodiment of FIG. 5B is substantially equivalent in form and function to that of the embodiment detailed and illustrated in FIG. 5A except as hereinafter specifically referenced. Specifically, the embodiment of FIG. 5B comprises 12V battery 210, primary ground 211 and secondary ground 212, wherein 12V battery 210, primary ground 211 and secondary ground 212 are concentric circles on the same vertical plane.

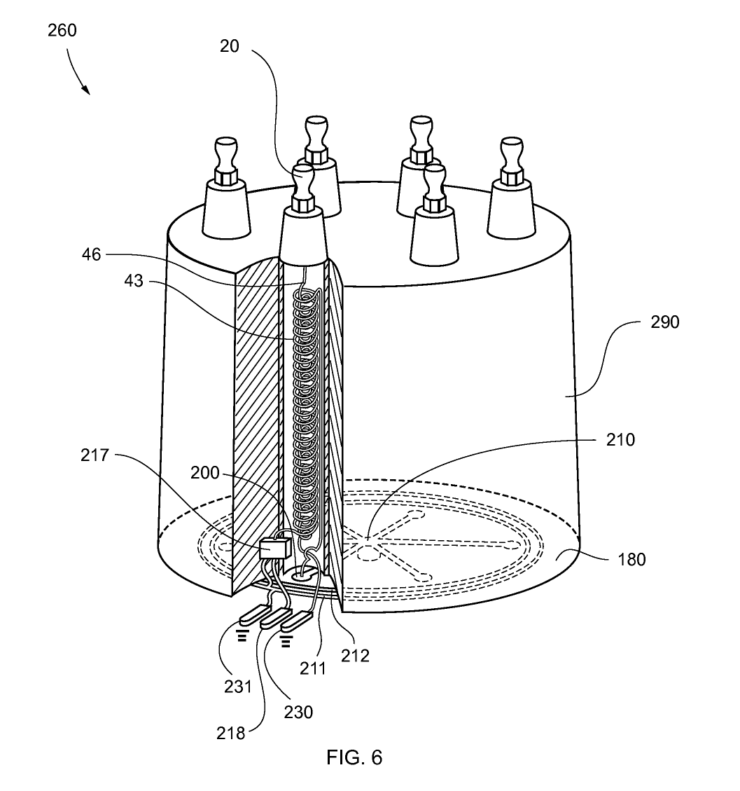

Referring now to FIG. 6, in a preferred embodiment, coil pack 260 slides into distributor cap 290, wherein coil pack 260 comprises primary ignition coils 43, secondary ignition coils 46, transistor 217 and base plate 180, wherein base plate 180 comprises 12V battery 210, primary ground 211 and secondary ground 212, and wherein primary ground 211 and secondary ground 212 are concentric circles on the same horizontal plane. Primary ignition coils 43 contact transistor 217 and 12V terminal 200, wherein 12V terminal 200 is in electrical communication with 12V battery 210. Secondary ignition coils 46 contact secondary ground terminal 230 and coil contact receptacles 20, wherein secondary ground terminal 230 is in electrical communication with secondary ground 212, and wherein secondary ground terminal 230 is external to distributor cap 290. Transistor 217 is in electrical communication with ECU trigger 218 and is in contact with primary ground terminal 231, wherein primary ground terminal 231 is in electrical communication with primary ground 211, and wherein primary ground terminal 231 is external to distributor cap 290. In use, ECU trigger 218 receives a signal from a computer, wherein the signal activates transistor 217 which energizes primary ignitions coils 43, wherein primary ignition coils 43 are powered via 12V terminal 200. Primary ignition coils 43 then energize secondary ignition coils 46, wherein secondary ignition coils 46 generate a spark in spark plug 12 through coil contact receptacles 20.

The foregoing description and drawings comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions and the associated drawings. Although specific terms may be employed herein, they are used in a generic and descriptive sense only and not for purposes of limitation. Accordingly, the present invention is not limited to the specific embodiments illustrated herein, but is limited only by the following claims.

What is claimed is:

1. A multiple coil distributor comprising:
a distributor, wherein said distributor comprises a distributor cap; and
a plurality of ignition coils, wherein said plurality of ignition coils are disposed within said distributor cap, and wherein said plurality of ignition coils each individually connect to an associated spark plug.

2. The multiple coil distributor of claim 1, further comprising an electronic control unit, wherein each of said plurality of ignition coils is in individual electrical communication with said electronic control unit.

3. The multiple coil distributor of claim 2, further comprising a sensor mechanism, wherein said sensor mechanism is in electrical communication with said electronic control unit.

4. The multiple coil distributor of claim 3, wherein said sensor mechanism is selected from the group consisting of Hall Effect sensors, optoelectronic sensors, and reluctors.

5. The multiple coil distributor of claim 4, wherein said sensor mechanism comprises said Hall Effect sensor, and wherein said sensor mechanism further comprises a trigger wheel, and wherein said trigger wheel comprises outside teeth spaced apart by outer gaps, and wherein said trigger wheel further comprises an inner ridge comprising at least one inner gap.

6. The multiple coil distributor of claim 5, wherein said outer gaps of said trigger wheel correspond to said an associated spark plug.

7. The multiple coil distributor of claim 6, wherein said sensor mechanism further comprises a secondary sensor and a primary sensor, and wherein said secondary sensor is dimensioned to receive said outside teeth of said trigger wheel, and wherein said primary sensor is dimensioned to receive said inner ridge of said trigger wheel.

8. The multiple coil distributor of claim 7, wherein rotation of said trigger wheel rotates said outside teeth through said secondary sensor of said sensor mechanism, and wherein said rotation of said trigger wheel rotates said inner ridge through said primary sensor of said sensor mechanism.

9. The multiple coil distributor of claim 8, wherein said primary sensor sends a signal to said electronic control unit when said primary sensor is aligned with said inner gap, thereby indicating the engine is at top dead center.

10. The multiple coil distributor of claim 9, wherein said secondary sensor sends a signal to said electronic control unit when said secondary sensor is transitioned by said outer gaps, thereby generating a spark to a selected ignition coil.

11. The multiple coil distributor of claim 10, wherein said spark to said selected ignition coil sparks its corresponding said spark plug.

12. The multiple coil distributor of claim 11, wherein said electronic control unit is optionally disposed within said distributor.

13. The multiple coil distributor of claim 11, wherein said electronic control unit further comprises additional sensor inputs for air and coolant temperature and throttle position.

14. The multiple coil distributor of claim 11, wherein said plurality of said ignition coils individually connect to said an associated spark plug, thereby eliminating reverse electromotive force.

15. A method of providing a spark for an internal combustion engine, said method comprising the steps of:
obtaining a multiple coil distributor, wherein said multiple coil distributor comprises a distributor, a distributor cap, a plurality of ignition coils housed within said distributor cap, a sensor mechanism comprising a trigger wheel and an electronic control unit; and
installing said multiple coil distributor within the engine compartment of a car.

16. The method of claim 15, said method further comprising the steps of:
rotating said trigger wheel; and
signaling said electronic control unit via said sensor mechanism when said trigger wheel is a selected position.

17. The method of claim 16, said method further comprising the step of:
sparking a selected ignition coil corresponding to a selected spark plug via said electronic control unit.

18. A multiple coil distributor comprising:
a distributor;
a distributor cap; and
ignition coils, wherein said ignition coils are housed within said distributor cap.

19. The multiple coil distributor of claim 18, further comprising a sensor mechanism, wherein said sensor mechanism comprises a trigger wheel.

20. The multiple coil distributor of claim 19, further comprising an electronic control unit, wherein said electronic control unit is in electrical communication with said sensor mechanism, and wherein said electronic control unit sparks a selected ignition coil that corresponds to a spark plug.

21. The multiple coil distributor of claim 1, wherein said plurality of ignition coils comprises a coil pack, and wherein said coil pack slides into said distributor cap, and wherein said coil pack further comprises a common external contact, and wherein said plurality of ignition coils are in electrical communication with ground via said common external contact.
